(19) United States
(12) Patent Application Publication
(10) Pub. No.: US 2023/0028091 A1
(43) Pub. Date: Jan. 26, 2023

(54) APPARATUS, SYSTEM, AND METHOD OF COMMUNICATION OVER A MILLIMETERWAVE (MMWAVE) CHANNEL ASSISTED BY COMMUNICATION OVER A SUB 10 GIGAHERTZ (GHZ) (SUB-10GHZ) CHANNEL

(71) Applicants: Laurent Cariou, Milizac (FR); Javier Perez-Ramirez, North Plains, OR (US); Dmitry Akhmetov, Hillsboro, OR (US); Dibakar Das, Hillsboro, OR (US)

(72) Inventors: Laurent Cariou, Milizac (FR); Javier Perez-Ramirez, North Plains, OR (US); Dmitry Akhmetov, Hillsboro, OR (US); Dibakar Das, Hillsboro, OR (US)

(21) Appl. No.: 17/958,342

(22) Filed: Oct. 1, 2022

(51) Int. Cl. H04W 72/12; H04W 16/28

(52) U.S. Cl. CPC H04W 72/1215; H04W 16/28; H04W 88/06

(57) ABSTRACT

An apparatus may be configured to perform communication over a millimeterWave (mmWave) channel assisted by communication over a sub 10 Gigahertz (GHz) (sub-10 GHz) channel. For example, a wireless communication device may be configured to identify a link block event including a blocking of an mmWave wireless communication link between an mmWave wireless communication station (STA) of the wireless communication device and an other wireless communication device. For example, the wireless communication device may be configured to, based on the link block event, communicate with the other wireless communication device over a sub-10 GHz wireless communication link between a sub-10 GHz STA of the wireless communication device and the other wireless communication device.

### TECHNICAL FIELD

Aspects described herein generally relate to communication over a millimeterWave (mmWave) wireless communication channel assisted by communication over a sub 10 Gigahertz (GHz) (sub-10 GHz) channel.

### BACKGROUND

Devices in a wireless communication system may be configured to communicate over a millimeterWave (mmWave) wireless communication channel.

There is a need to provide a technical solution to support efficient and/or reliable communication over the mmWave wireless communication channel.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of communications between a first wireless communication device and a second wireless communication device according to a communication scheme utilizing a millimeterWave (mmWave) link and a sub 10 Gigahertz (GHz) (sub-10 GHz) link, in accordance with some demonstrative aspects.

FIG. 5 is a schematic illustration of communications between a first wireless communication device and a second wireless communication device according to a communication scheme utilizing an mmWave link and a sub-10 GHz link, in accordance with some demonstrative aspects.

FIG. 6 is a schematic illustration of communications between a first wireless communication device and a second wireless communication device according to a communication scheme utilizing an mmWave link and a sub-10 GHz link, in accordance with some demonstrative aspects.

FIG. 7 is a schematic flow-chart illustration of a method of communication over an mmWave wireless communication channel assisted by communication over a sub-10 GHz channel, in accordance with some demonstrative aspects.

FIG. 8 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D2.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), May 2022)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by a mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

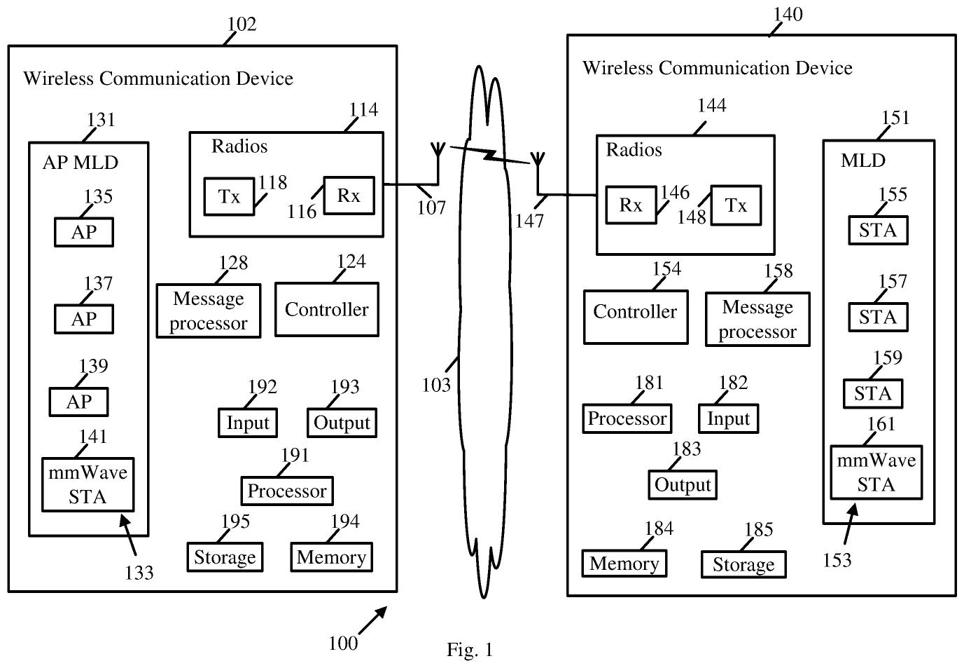

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102, and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band.

In other aspects, WM 103 may include any other type of channel over any other frequency band.

In some demonstrative aspects, device 102 and/or device 140 may include one or more radios including circuitry and/or logic to perform wireless communication between devices 102, 140, and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a sub-10 Ghz band, for example, 2.4 GHz band, a 5 GHz band, a 6 GHz band, and/or any other sub-10 GHz band; and/or an mmWave band, e.g., a 45 Ghz band, a 60 Ghz band, and/or any other mmWave band; and/or any other band, e.g., a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more, e.g., a plurality of, antennas 107, and/or device 140 may include one or more, e.g., a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, device 102 and/or device 140 may include, operate as, perform the role of, and/or perform one or more functionalities of, one or more mmWave STAs, e.g., DMG STAs, EDMG STAs, and/or any other mmWave STA. For example, device 102 may include, operate as, perform the role of, and/or perform one or more functionalities of, one or more mmWave STAs, and/or device 140 may include, operate as, perform the role of, and/or perform one or more functionalities of, one or more mmWave STAs.

In other aspects, devices 102, and/or 140 may include, operate as, perform the role of, and/or perform one or more functionalities of, any other wireless device and/or station, e.g., a WLAN STA, a WiFi STA, and the like.

In some demonstrative aspects, device 102 and/or device 140 may be configured to operate as, perform the role of, and/or perform one or more functionalities of, an access point (AP), e.g., an EHT AP STA.

In some demonstrative aspects, device 102 and/or device 140 may be configured to operate as, perform the role of, and/or perform one or more functionalities of, a non-AP STA, e.g., an EHT non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, and/or any other network.

In some demonstrative aspects, devices 102 and/or 140 may be configured to operate in accordance with one or more Specifications, for example, including one or more IEEE 802.11 Specifications, e.g., an IEEE 802.11-2020 Specification, an IEEE 802.11be Specification, an IEEE 802.11 ay Specification and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity and has more than one affiliated STA and has a single MAC service access point (SAP) to LLC, which includes one MAC data service. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-APSTA.

In some demonstrative aspects, controller 124 may be configured to control, perform and/or to trigger, cause, instruct and/or control device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, a mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 Ghz band, as described below.

In some demonstrative aspects, for example, the one or more radios 114 may include, for example, a radio for communication by AP STA 137 over a second wireless communication frequency channel and/or frequency band, e.g., a 5 Ghz band, as described below.

In some demonstrative aspects, for example, the one or more radios 114 may include, for example, a radio for communication by AP STA 139 over a third wireless communication frequency channel and/or frequency band, e.g., a 6 Ghz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 45 Ghz, for example, a 60 GHz band or any other mmWave band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects controller 124 may be configured to control, perform and/or to trigger, cause, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, perform and/or to trigger, cause, instruct and/or control device 140 to operate as, perform a role of, and/or perform one or more operations and/or functionalities of, an MLD 151 including a plurality of STAs 153, e.g., including a STA 155, a STA 157, a STA 159, and/or a STA 161. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 Ghz band, as described below.

In some demonstrative aspects, for example, the one or more radios 144 may include, for example, a radio for communication by STA 157 over a second wireless communication frequency channel and/or frequency band, e.g., a 5 Ghz band, as described below.

In some demonstrative aspects, for example, the one or more radios 144 may include, for example, a radio for communication by STA 159 over a third wireless communication frequency channel and/or frequency band, e.g., a 6 Ghz band, as described below.

In some demonstrative aspects, for example, the one or more radios 144 may include, for example, a radio for communication by mmWave STA 161 over a fourth wireless communication frequency channel and/or frequency band, e.g., a mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, perform and/or to trigger, cause, instruct and/or control MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, perform and/or to trigger, cause, instruct and/or control MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects controller 154 may be configured to control, perform and/or to trigger, cause, instruct and/or control device 140 to operate as, perform a role of, and/or perform one or more operations and/or functionalities of, any other additional or alternative entity and/or STA, e.g., a single STA, multiple STAs, and/or a non-MLD entity.

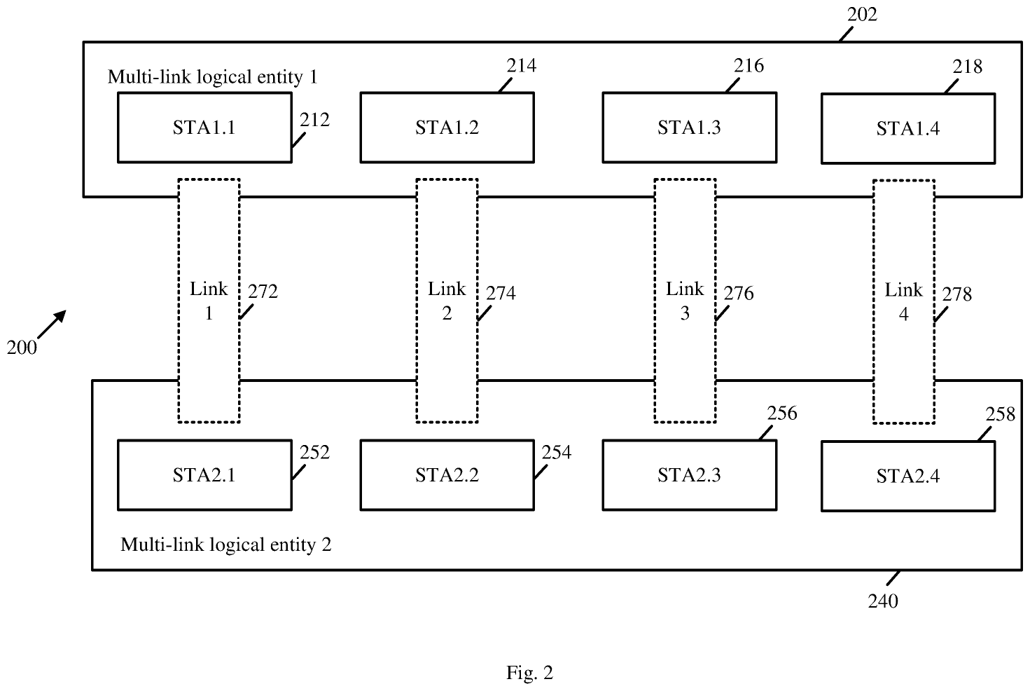

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

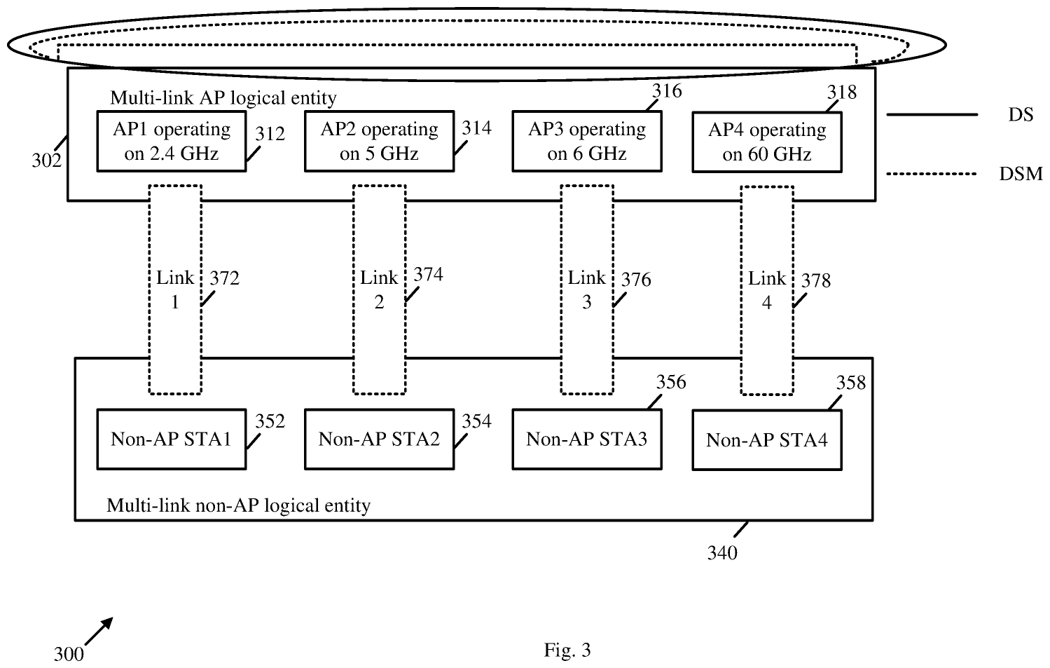

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 Ghz frequency band, AP STA 314 may be configured to communicate over a 5 Ghz frequency band, AP STA 316 may be configured to communicate over a 6 Ghz frequency band, and/or mmWave STA 318 may be configured to communicate over a mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, device 102 and/or device 140 may be configured to support a technical solution for communication between mmWave STAs, e.g., mmWave STA 141 and mmWave STA 161, over the mmWave frequency band, e.g., as described below.

In some demonstrative aspects, device 102 and/or device 140 may be configured to support a technical solution to utilize communications over the sub-10 GHz frequency band, for example, to assist one or more operations to be performed by the mmWave STAs, e.g., mmWave STA 141 and/or mmWave STA 161, over the mmWave frequency band, e.g., as described below.

In some demonstrative aspects, device 102 and/or device 140 may be configured to support a technical solution, which may utilize communications over the sub-10 GHz frequency band, for example, to support enhanced throughput provided by mmWave techniques.

In some demonstrative aspects, device 102 and/or device 140 may be configured to support a technical solution, which may be based on, and/or may utilize, a multi-link framework, for example, according to an MLD architecture, e.g., as described above.

In some demonstrative aspects, device 102 and/or device 140 may be configured to utilize the multi-link framework, for example, to provide a technical solution to support improved operation on multiple links, e.g., as described below.

In some demonstrative aspects, device 102 and/or device 140 may be configured to utilize the multi-link framework to provide a technical solution to compensate for a fragility of an mmWave link, e.g., a 60 GHz link, for example, through a fallback to sub-10 GHz band (lower band) operation, e.g., as described below.

In some demonstrative aspects, device 102 and/or device 140 may be configured to utilize a mmWave PHY design, which may be based on, or may include one or more elements and/or functionalities of a PHY design, which may be configured to support communication over a sub-10 GHz band, for example, in accordance with an IEEE 802.11ac Specification and/or any other Specification.

In some demonstrative aspects, device 102 and/or device 140 may be configured to implement an MLD, which may be configured to support communication over mmWave links, e.g., in the 60 Ghz band, and Sub-10 GHz links, e.g., in the sub-7 Ghz band, as described above.

In some demonstrative aspects, in some use cases, scenarios and/or implementations, there may be a need to address one or more technical issues of a relatively high channel attenuation when communicating in mmWave bands, e.g., in 60 GHz bands.

In some demonstrative aspects, device 102 and/or device 140 may be configured to utilize mmWave communication techniques, which may be based on, and/or may utilize, highly directional PPDU transmissions, for example, to overcome the high channel attenuation in the 60 GHz bands.

In some demonstrative aspects, a pair of STAs, e.g., device 102 and/or device 140, may be configured to perform beamforming training (BFT), for example, to support highly directional PPDU transmissions.

In some demonstrative aspects, the pair of STAs, e.g., device 102 and/or device 140, may perform the BFT, for example, to determine antenna settings, e.g., antenna weight vectors (AWVs), for data communication between them.

In some demonstrative aspects, while the BFT may be used by the pair of STAs to arrive at a semi-static antenna weight vector (AWV) configuration, it is possible that a path corresponding to an AWV derived during the BFT may occasionally be blocked, for example, due to user mobility.

For example, a link quality of an mmWave link between the pair of STAs may be affected, for example, by partial or even full blockage line-of-sight (LOS) between the pair of devices.

For example, the LOS between the pair of devices may be blocked when a person or object moves into the LOS.

In one example, a link quality of an mmWave link between a laptop, e.g., acting as a 60 GHz soft-AP, and a head mounted device (HMD), e.g., acting as a client associated to the 60 GHz soft-AP, may be affected by blockage of a LOS between the laptop and the HMD. For example, the blockage of a LOS between the laptop and the HMD may be blocked as a result of a movement performed by a user of the HMD, movement of the laptop, and/or movement of another person and/or object into the LOS.

In one example, in some cases, the blockage of the LOS may result in limited communication over the mmWave link, e.g., communication may be limited to lower data rates, for example, in case of a relatively short distance between the pair of devices. However, in other cases, the blockage of the LOS may result in the mmWave link becoming unavailable, for example, in case of a relatively large distance between the pair of devices.

In some demonstrative aspects, device 102 and/or device 140 may be configured to implement a link recovery mechanism to provide a technical solution to support recovery from a link blockage event of an mmWave link, e.g., as described below.

In some demonstrative aspects, the link recovery mechanism, may be configured to provide a technical solution to support fast link recovery from the link blockage event, e.g., as described below.

In some demonstrative aspects, the link recovery mechanism, may be configured to provide a technical solution to support communication over mmWave links with relatively low latency and/or relatively high reliability.

For example, some flows, e.g., such as Inertial Measurement Unit (IMU) tracking, may have a relatively tight latency bound, e.g., in the order of a few milliseconds (ms). Accordingly, performance of these flows may be severely degraded, for example, in case the mmWave link is not recovered quickly enough from a link blockage event.

For example, some applications, e.g., applications related to Extended reality (XR) and/or any other applications, may require wireless communication links supporting high throughout, high reliability, and/or low latency.

In one example, XR applications may involve high throughput video traffic from a renderer device, e.g., a laptop and/or a cloud service via an infrastructure AP, to a headset/HMD.

For example, XR applications may require support of a very low latency budget, for example, for tracking pose data from the headset/HMD to the renderer device.

For example, XR applications may require support of a high level of scalability, e.g., to support several users in the same room participating in a collaborative XR session.

For example, it may be challenging to meet these requirements, e.g., using sub-7 GHz channels, for example, due to limited number of large BW channels and/or limited opportunities for spatial reuse over the sub-7 GHz bands.

For example, in opposed to the limited performance supported by the sub-7 GHz band, the mmWave band, e.g., the 60 GHz channels, may provide a high, e.g., a very high, channel BW resulting in a high data rate and/or a low latency, for example, while also providing opportunities for spatial reuse, e.g., considering a relatively high propagation loss in the mmWave band.

In some demonstrative aspects, a wireless communication device, e.g., device 102 and/or device 140, may be configured to identify a link block event, e.g., as described below.

In some demonstrative aspects, the link block event may include a blocking of an mmWave wireless communication link between an mmWave STA of the wireless communication device and an other wireless communication device, e.g., as described below.

In some demonstrative aspects, the wireless communication device, e.g., device 102 and/or device 140, may be configured to communicate with the other wireless communication device over a sub-10 GHz wireless communication link between a sub-10 GHz STA of the wireless communication device and the other wireless communication device, for example, based on the link block event, e.g., as described below.

In some demonstrative aspects, the wireless communication device may include an AP device, the sub-10 GHz STA may include a sub-10 GHz AP, and the mmWave STA may include an mmWave AP.

For example, an AP device implemented by device 102, e.g., AP MLD 133, may be configured to identify a link block event including a blocking of an mmWave wireless communication link between mmWave STA 141 of device 102 and a non-AP device implemented by device 140.

For example, the AP device implemented by device 102 may be configured to, for example, based on the link block event, communicate with the non-AP device implemented by device 140 over a sub-10 GHz wireless communication link between a sub-10 GHz AP of device 102, e.g., AP 135, and device 140.

In some demonstrative aspects, the wireless communication device may include a non-AP device, the sub-10 GHz STA may include a sub-10 GHz non-AP STA, and the mmWave STA may include an mmWave non-AP STA.

For example, a non-AP device implemented by device 140, e.g., non-AP MLD 153, may be configured to identify a link block event including a blocking of an mmWave wireless communication link between mmWave STA 161 of device 140 and an AP device implemented by device 102.

For example, the non-AP device implemented by device 140 may be configured to, for example, based on the link block event, communicate with the AP device implemented by device 102 over a sub-10 GHz wireless communication link between a sub-10 GHz STA of device 140, e.g., STA 155, and device 102.

In some demonstrative aspects, the sub-10 GHz wireless communication channel may include a sub-7 GHz channel, for example, a 2.4 GHz channel, a 5 GHz channel, a 6 GHz channel, and/or any other sub-10 GHz wireless communication channel, e.g., as described above.

In some demonstrative aspects, the mmWave wireless communication channel may include a 60 GHz channel. In other aspects, the mmWave wireless communication channel may include any other mmWave channel.

In some demonstrative aspects, the wireless communication device, e.g., device 102 and/or device 140, may be configured to identify the link block event, for example, based on an identified failure of a data transmission from the mmWave STA of the wireless communication device to the other wireless communication device, e.g., as described below.

For example, controller 124 may control device 102 to identify the link block event, for example, based on an identified failure of a data transmission from mmWave STA 141 of device 102 to device 140.

For example, controller 154 may control device 140 to identify the link block event, for example, based on an identified failure of a data transmission from mmWave STA 161 of device 140 to device 102.

In some demonstrative aspects, the wireless communication device, e.g., device 102 and/or device 140, may be configured to operate the sub-10 GHz STA of the wireless communication device to transmit the data transmission to the other wireless communication device over the sub-10 GHz wireless communication link, for example, based on the link block event, e.g., as described below.

For example, controller 124 may control device 102 to operate AP 135 to transmit the data transmission to device 140 over the sub-10 GHz wireless communication link, for example, based on the link block event.

For example, controller 154 may control device 140 to operate STA 155 to transmit the data transmission to device 102 over the sub-10 GHz wireless communication link, for example, based on the link block event.

In some demonstrative aspects, the wireless communication device, e.g., device 102 and/or device 140, may be configured to identify the link block event, for example, based on an identified failure of receipt of an expected transmission from the other wireless communication device over the mmWave wireless communication link, e.g., as described below.

In some demonstrative aspects, the wireless communication device, e.g., device 102 and/or device 140, may be configured to identify the link block event, for example, based on an identified failure of receipt of an expected response to a transmission from the mmWave STA of the wireless communication device over the mmWave wireless communication link, e.g., as described below.

In some demonstrative aspects, the wireless communication device, e.g., device 102 and/or device 140, may be configured to identify the link block event, for example, based on an identified failure of receipt of a transmission from the other wireless communication device over the mmWave wireless communication link within a threshold time since a beginning of a Service Period (SP), e.g., as described below.

In some demonstrative aspects, the wireless communication device, e.g., device 102 and/or device 140, may be configured to identify the link block event, for example, based on an identified failure to receive an expected data transmission from the other wireless communication device over the mmWave wireless communication link, e.g., as described below.

For example, controller 124 may control device 102 to identify the link block event, for example, based on an identified failure to receive an expected data transmission from device 140 over the mmWave wireless communication link.

For example, controller 154 may control device 140 to identify the link block event, for example, based on an identified failure to receive an expected data transmission from device 102 over the mmWave wireless communication link.

In some demonstrative aspects, the wireless communication device, e.g., device 102 and/or device 140, may be configured to operate the sub-10 GHz STA of the wireless communication device to receive the data transmission from the other wireless communication device over the sub-10 GHz wireless communication link, for example, based on the link block event, e.g., as described below.

For example, controller 124 may control device 102 to operate AP 135 of to receive the data transmission from device 140 over the sub-10 GHz wireless communication link, for example, based on the link block event.

For example, controller 154 may control device 140 to operate STA 155 to receive the data transmission from device 102 over the sub-10 GHz wireless communication link, for example, based on the link block event.

In some demonstrative aspects, the wireless communication device, e.g., device 102 and/or device 140, may be configured to operate at an Enhanced Multi-Link Single Radio (EMLSR) mode, for example, to simultaneously listen over both the mmWave wireless communication link and the sub-10 Ghz wireless communication link, e.g., as described below.

In some demonstrative aspects, the wireless communication device, e.g., device 102 and/or device 140, may be configured to switch the sub-10 GHz STA of the wireless communication device from a low power state to an active state, for example, based on the link block event, e.g., as described below.

In some demonstrative aspects, the wireless communication device, e.g., device 102 and/or device 140, may be configured to operate the sub-10 GHz STA of the wireless communication device to transmit over the sub-10 GHz link a transmission configured to indicate the link block event to the other wireless communication device, e.g., as described below.

In some demonstrative aspects, the wireless communication device, e.g., device 102 and/or device 140, may be configured to identify the link block event, for example, based on an identified predefined change of a link condition corresponding to the mmWave wireless communication link, e.g., as described below.

In some demonstrative aspects, device 102 and/or device 140 may be configured to implement one or more channel blockage identification/signaling mechanisms to identify and/or signal that an mmWave link is blocked, e.g., as described below.

In some demonstrative aspects, a transmitter STA, e.g., implemented by device 102 and/or device 140, may conclude that a channel between the transmitter STA and a receiver STA has been blocked, for example, when the transmitter STA has not received an expected reply to transmitted frames, for example, after n attempts since a start of an SP.

In some demonstrative aspects, a receiver STA, e.g., implemented by device 102 and/or device 140, may conclude that a channel between the receiver STA and a transmitter STA has been blocked, for example, when the receiver STA has not received expected frames, for example, within a threshold time since a start of an SP in which the receiver STA is expected to receive frames, and/or the channel is otherwise sensed to be idle.

In one example, a threshold duration may be predefined, for example, in a Specification.

In another example, the transmitter STA and the receiver STA may negotiate the threshold duration.

For example, the transmitter STA and/or the receiver STA may signal the threshold duration during a Target Wake Time (TWT) SP setup. In another example, the transmitter STA and/or the receiver STA may signal the threshold duration during an association/discovery phase, and/or during any other communication phase.

In some demonstrative aspects, a receiver STA, e.g., implemented by device 102 and/or device 140, may conclude that a channel between the receiver STA and a transmitter STA has been blocked or is likely to be blocked, for example, when the receiver STA experiences a change, e.g., a sudden change, in a channel condition of the channel, e.g., a sudden change in a Received Signal Strength Indicator (RSSI) on received frames.

For example, the receiver STA may conclude a link has entered a channel blockage, for example, when the RSSI drops below a certain RSSI threshold. In one example, the RSSI threshold may be predefined, e.g., in a Specification. In another example, the RSSI threshold may be or negotiated between the receiver STA and the transmitter STA.

In some demonstrative aspects, a STA affiliated with an MLD, e.g., implemented by device 102 and/or device 140, may conclude that a channel between the STA and a peer MLD has been blocked.

In some demonstrative aspects, the STA affiliated with the MLD may conclude that the MLD has another link setup with the peer MLD on a sub-7 GHz link.

In some demonstrative aspects, the STA affiliated with the MLD may inform a STA of the peer MLD of a link block event, for example, via a transmission on the sub-7 GHz link.

In one example, the link block event may be signaled, for example, by piggy-backing information in one or more Data frames, e.g., via an A-Ctrl field. In another example, the link block event may be signaled as part of a new management (Mg) frame and/or a control (Ctrl) frame.

In some demonstrative aspects, a transmitter STA, e.g., implemented by device 102 and/or device 140, may explicitly inform a peer STA, for example, by a frame transmission using a Control (Ctrl) Mode PHY, for example, when the transmitter STA concludes that a channel between the transmitter STA and the peer STA has been blocked.

In some demonstrative aspects, a pair of STAs communicating over a 60 GHz link, e.g., a STA implemented device 102 and/or a STA implemented device 140, may exchange, e.g., periodically, link quality information for the 60 GHz link.

In some demonstrative aspects, the pair of STAs may communicate the link quality information for the 60 GHz link via transmissions in the sub-7 GHz link, for example, to allow the pair of STAs to identify a link block event, e.g., a channel blockage event.

In some demonstrative aspects, device 102 and/or device 140 may be configured to implement a communication scheme to communicate to support communication based on an identified link block event, e.g., as described below.

In some demonstrative aspects, a wireless communication device, e.g., device 102 and/or device 140, may be configured to setup a first SP over an mmWave wireless communication link between the wireless communication device and another wireless communication device, e.g., as described below.

In some demonstrative aspects, the wireless communication device, e.g., device 102 and/or device 140, may be configured to setup a second SP over a sub-10 GHz wireless communication link between the wireless communication device and the other wireless communication device, e.g., as described below.

In some demonstrative aspects, the second SP may at least partially overlap, with the first SP.

In some demonstrative aspects, the wireless communication device, e.g., device 102 and/or device 140, may be configured to operate an mmWave STA of the wireless communication device to communicate with the other wireless communication device over the mmWave wireless communication link during the first SP, e.g., as described below.

In some demonstrative aspects, the wireless communication device, e.g., device 102 and/or device 140, may be configured to operate a sub-10 GHz STA of the wireless communication device to communicate with the other wireless communication device over the sub-10 GHz wireless communication link during the second SP, for example, based on identifying a link block event during the first SP, e.g., as described below.

For example, controller 124 may control device 102 to setup a first SP over an mmWave wireless communication link between device 102 and device 140, and a second SP over a sub-10 GHz wireless communication link between device 102 and device 140. For example, controller 124 may control device 102 to operate mmWave STA 141 to communicate with device 140 over the mmWave wireless communication link during the first SP. For example, controller 124 may control device 102 to operate AP 135 to communicate with device 140 over the sub-10 GHz wireless communication link during the second SP, for example, based on identifying a link block event including a blocking of the mmWave wireless communication link during the first SP.

For example, controller 154 may control device 140 to setup a first SP over a mmWave wireless communication link between device 140 and device 102, and a second SP over a sub-10 GHz wireless communication link between device 140 and device 102. For example, controller 154 may control device 140 to operate mmWave STA 161 to communicate with device 102 over the mmWave wireless communication link during the first SP. For example, controller 154 may control device 140 to operate STA 155 to communicate with device 102 over the sub-10 GHz wireless communication link during the second SP, for example, based on identifying a link block event including a blocking of the mmWave wireless communication link during the first SP.

In some demonstrative aspects, the wireless communication device, e.g., device 102 and/or device 140, may be configured to operate the sub-10 GHz STA of the wireless communication device to transmit BF information to the other wireless communication device over the sub-10 GHz wireless communication link, for example, based on the link block event, e.g., as described below.

In some demonstrative aspects, the BF information may include an indication of a BF configuration for a subsequent transmission over the mmWave wireless communication link, e.g., as described below.

In some demonstrative aspects, the BF information may include BF training setup information to setup one or more BF training windows for the mmWave wireless communication link, e.g., as described below.

In some demonstrative aspects, the wireless communication device, e.g., device 102 and/or device 140, may be configured to setup the first SP as a main SP for communication with the other wireless communication device, e.g., as described below.

In some demonstrative aspects, the wireless communication device, e.g., device 102 and/or device 140, may be configured to setup the second SP as a backup SP to be activated, for example, based on the link block event, e.g., as described below.

In some demonstrative aspects, the first SP may include a first TWT SP over the mmWave wireless communication link, and/or the second SP may include a second TWT SP over the sub-10 GHz wireless communication link, e.g., as described below.

In some demonstrative aspects, the wireless communication device, e.g., device 102 and/or device 140, may be configured to operate the sub-10 GHz STA of the wireless communication device to transmit to the other wireless communication device a recommendation to reduce an order of a Modulation and Coding Scheme (MCS) for communication over the mmWave wireless communication link, e.g., as described below.

In some demonstrative aspects, device 102 and/or device 140 may be configured to implement blockage-based communication mechanism to communicate based on identification of a link block event, e.g., as described below.

In some demonstrative aspects, a transmitter device, e.g., implemented by device 102 and/or 140, may have a high priority data frame to transmit, for example, while the transmitter concludes that an mmWave wireless communication channel has been blocked.

In some demonstrative aspects, the transmitter device may be configured to prioritize transmission of the high priority data frame, for example, before attempting to find new AWV parameters, e.g., before initiating a new BFT.

In one example, the transmitter device may initiate transmission using a lower MCS on the 60 GHz link, e.g., using a Ctrl mode, e.g., based on an identified link block event, for example, to flush pending packets, e.g., including any high-priority data frames.

In another example, the transmitter device may initiate transmission of the high priority data frame, for example, on a sub-7 GHz link.

In some demonstrative aspects, a wireless communication device, e.g., implemented by device 102 and/or device 140, may operate an mmWave STA over an mmWave link, and may identify a link block event, e.g., a channel blockage, of the mmWave link. The wireless communication device, e.g., implemented by device 102 and/or device 140, may switch a STA of the wireless communication device, which is not currently awake on a sub-7 GHz link, e.g., due to a power save (PS) mode, to become available for data communication on the sub-7 GHz link, for example, based on detection of the link block event.

In some demonstrative aspects, a pair of MLDs, e.g., including an MLD implemented by device 102 and/or an MLD implemented by device 140, may setup overlapping TWT SPs, e.g., at least partially overlapping TWT SPs, for example, including a TWT SP on the 60 GHz link and a TWT SP on the sub-7 GHz link. For example, the TWT SP in the sub-7 GHz link may be used, e.g., may only be used, when the 60 GHz link becomes unavailable.

In some demonstrative aspects, the pair of MLDs, e.g., implemented by device 102 and/or device 140, may utilize an additional signaling during a TWT SP negotiation, for example, to identify one of the links, e.g., the sub-7 GHz link, as a backup link.

In some demonstrative aspects, for example, following the activation of the sub-7 GHz link based on a link block event of the 60 Ghz link, the sub-7 GHz link may be used as the main link, for example, until a new BFT for the 60 GHz link is performed, and/or until the channel blockage is determined to be over.

In some demonstrative aspects, a STA, e.g., implemented by device 102 and/or device 140, may transmit a frame in the sub-7 GHz link, for example, to signal any alternate BF setting, e.g., an alternate AWV and/or an alternate sector, to be used for a next transmission in the 60 GHz link.

In some demonstrative aspects, the frame in the sub-7 GHz link may be configured to include information, for example, to signal a time of the next transmission in the 60 GHz link.

In some demonstrative aspects, the STA, e.g., device 102 and/or device 140, may transmit a frame in the sub-7 GHz link including BF scheduling information, for example, to schedule one or more time-windows for a new beamforming training procedure for the 60 GHz link. For example, the BF scheduling information may be communicated utilizing one or more of the following options:
Using a cross-link TWT Information frame containing an additional element including the BF scheduling information, for example, to signal parameters for a BFT procedure.
Extending the frame signaling allocation to include an additional element including the BF scheduling information, for example, to signal the parameters for the BFT procedure on the 60 GHz link.
Transmitting a new management frame and/or a Ctrl frame including the BF scheduling information.

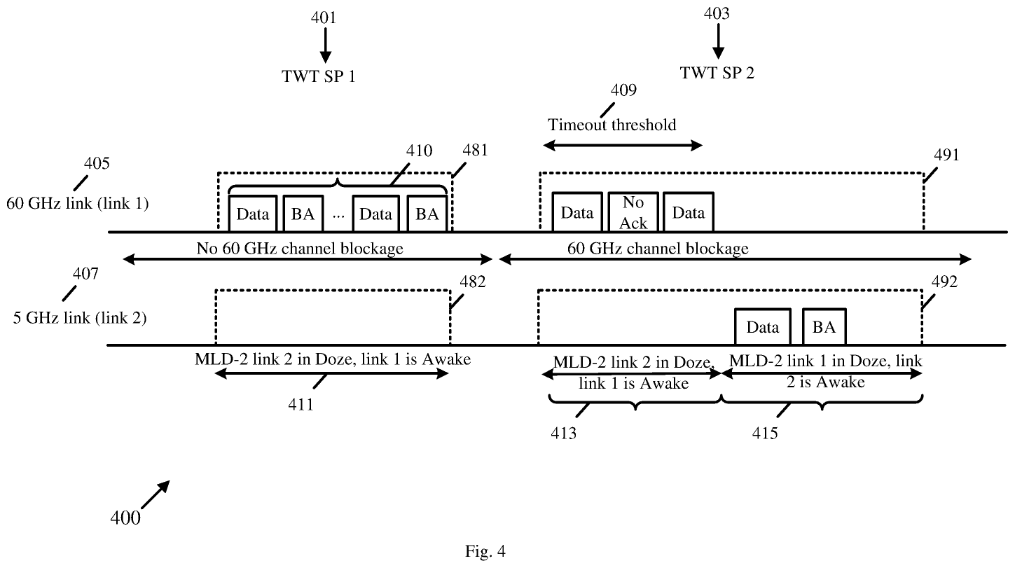

Reference is made to FIG. 4, which schematically illustrates communications between a first wireless communication device and a second wireless communication device according to a communication scheme 400 utilizing an mmWave link and a sub-10 GHz link, in accordance with some demonstrative aspects.

In some demonstrative aspects, communication scheme 400 may be configured to support communication between the first wireless communication device and the second wireless communication device, for example, following a link block event (a medium blockage event), e.g., as described below.

For example, the link block event may include a blocking of an mmWave wireless communication link between the first wireless communication device and the second wireless communication device.

In some demonstrative aspects, as shown in FIG. 4, the first wireless communication device and the second wireless communication device may start operating on lower sub-7 GHz link on an overlapping SP, for example, following the link block event, e.g., as described below.

In some demonstrative aspects, as shown in FIG. 4, the first wireless communication device and the second wireless communication device may set up overlapping SPs on a 60 GHz link 405 (link 1) and a sub-7 GHz link 407 (link 2). For example, the sub-7 GHz link 407 may be used, e.g., opportunistically, when the 60 GHz link 405 is blocked.

In some demonstrative aspects, an MLD-1, e.g., acting as an AP/soft-AP, and/or an MLD-2, e.g., acting as a client, may setup overlapping SPs on two links, for example, on the 60 GHz link 405 and the sub-7 GHz link 407. For example, the MLD-2 may be configured, e.g., due to Power-Save (PS) reasons, to turn on the sub-7 GHz link 407, for example, only when the 60 GHz link 405 becomes unavailable.

For example, device 102 (FIG. 1) may perform one or more operations of, one or more functionalities of, the role of, and/or the functionality of, the first wireless communication device, e.g., the MLD-1.

For example, device 140 (FIG. 1) may perform one or more operations of, one or more functionalities of, the role of, and/or the functionality of, the second wireless communication device, e.g., the MLD-2.

In some demonstrative aspects, the MLD-1 and the MLD-2 may set up a first pair of TWT SPs 401, for example, including a first TWT SP 481 over the mmWave wireless communication link, and a second TWT SP 482 over the sub-10 GHz wireless communication link.

In some demonstrative aspects, as shown in FIG. 4, TWT SP 481 may at least partially overlap with TWT SP 482.

In some demonstrative aspects, the MLD-1 and the MLD-2 may set up a second pair of TWT SPs 403, for example, including a first TWT SP 491 over the mmWave wireless communication link, and a second TWT SP 492 over the sub-10 GHz wireless communication link.

In some demonstrative aspects, as shown in FIG. 4, TWT SP 491 may at least partially overlap with TWT SP 492.

In some demonstrative aspects, as shown in FIG. 4, there may be no link block event, e.g., no blockage, over the 60 GHz link 405 between the MLD-1 and MLD-2, e.g., during the TWT SP 481.

In some demonstrative aspects, as shown in FIG. 4, the two STAs, e.g., the MLD-1 and/or the MLD-2, may be able to communicate data and block acknowledgement (BA) frames 410 over the 60 GHz link 405 during the TWT SP 481, for example, as long as the channel between the two STAs is not blocked.

In some demonstrative aspects, as shown in FIG. 4, during a time period 411, the MLD-2 may operate in an awake state over the 60 GHz link 405, for example, by maintaining a STA of the MLD-2 awake for communication over the 60 GHz link 405.

In some demonstrative aspects, as shown in FIG. 4, during the time period 411, the MLD-2 may operate in a doze state over the sub-7 Ghz link 407, for example, by maintaining a STA of the MLD-2 at a PS (doze) state over the sub-7 GHz link 407.

In some demonstrative aspects, as shown in FIG. 4, the MLD-1 and/or MLD-2 may operate at low power state, e.g., in a PS mode, over the sub-7 GHz link 407, for example, during the time period 411, e.g., as long as the 60 GHz link 405 between the two STAs is not blocked.

In some demonstrative aspects, the MLD-1 may identify a link block event, for example, based on an identified failure of receipt of an expected response to a transmission from the mmWave STA of the MLD-1 over the 60 GHz link 405.

In some demonstrative aspects, as shown in FIG. 4, the MLD-1 may conclude that the 60 GHz link 405 (link 1) is blocked during the TWT SP 491, for example, based on a determination that initial data transmission attempts on the 60 GHz link 405 are not successful.

For example, as shown in FIG. 4, the MLD-1 may fail to receive any acknowledgement from the MLD-2 in response to data transmission attempts on the 60 GHz link 405 during the TWT SP 491.

In some demonstrative aspects, the MLD-2 may identify the link block event, for example, based on an identified failure of receipt of the data transmission from the MLD-1 over the 60 GHz link 405 within a threshold time 409 since a beginning of the TWT SP 491.

In some demonstrative aspects, as shown in FIG. 4, the MLD-1 may attempt to communicate with the MLD-2 on the sub-7 GHz link 407 (link 2), for example, based on the link block event identified by the MLD-1.

In some demonstrative aspects, as shown in FIG. 4, the MLD-2 may continue to operate in the awake state over the 60 GHz link 405 (link 1), and to operate in the doze state over the sub-7 GHz link 407 (link 2), for example, during a time period 413, for example, as long as the MLD-2 has not identified the link block event over the 60 GHz link 405.

In some demonstrative aspects, as shown in FIG. 4, the MLD-2 may switch its STA on the sub-7 GHz link 407 (link 2) from a low power state to an active state, for example, based on the identified link block event over the 60 GHz link 405. For example, the MLD-2 may activate its STA on the sub-7 GHz link 407 (link 2), for example, when the MLD-2 does not receive any expected frame transmission within the specified timeout threshold 409 on the 60 GHz link 405 (link 1).

In some demonstrative aspects, as shown in FIG. 4, the MLD-1 and the MLD-2 may communicate over sub-7 GHz link 407 during a time period 415 within the TW SP 492.

In some demonstrative aspects, as shown in FIG. 4, the MLD-1 and/or the MLD-2 may switch the 60 GHz link 405 to a low power mode (doze) and may maintain the 60 GHz link 405 at the low power mode (doze) during the time period 415, for example, based on the link block event.

In some demonstrative aspects, as shown in FIG. 4, the MLD-1 may transmit a data transmission to the MLD-2 over the sub-7 GHz link 407 during period 415, for example, based on the identified link block event.

In some demonstrative aspects, as shown in FIG. 4, the MLD-2 may receive the data transmission from the MLD-1 over the sub-7 GHz link 407 during period 415, for example, after identifying the link block event.

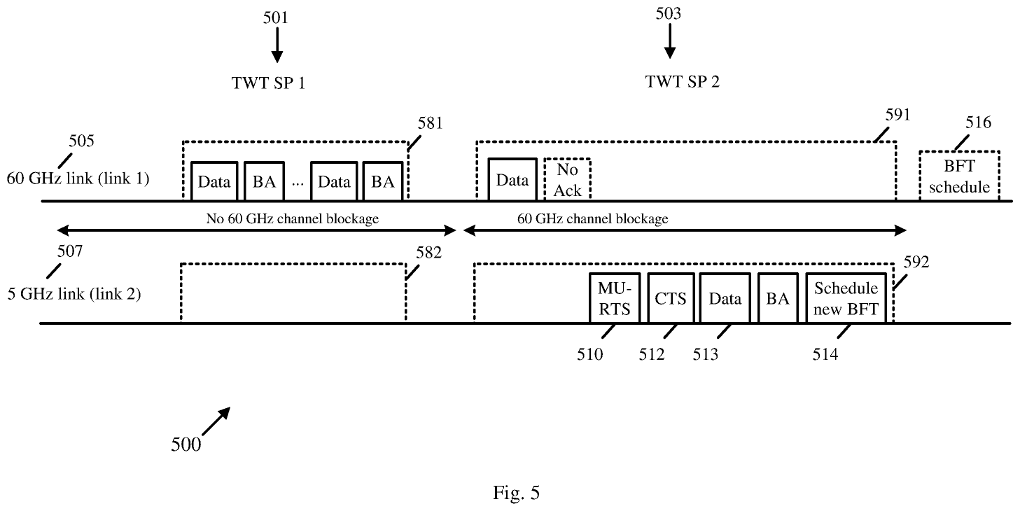

Reference is made to FIG. 5, which schematically illustrates communications between a first wireless communication device and a second wireless communication device according to a communication scheme 500 utilizing an mmWave link and a sub-10 GHz link, in accordance with some demonstrative aspects.

In some demonstrative aspects, communication scheme 500 may be configured to support communication between the first wireless communication device and the second wireless communication device, for example, following a link block event (a medium blockage event), e.g., as described below.

For example, the link block event may include a blocking of an mmWave wireless communication link between the first wireless communication device and the second wireless communication device.

In some demonstrative aspects, as shown in FIG. 5, the first wireless communication device and the second wireless communication device may start operating on lower sub-7 GHz link on an overlapping SP, for example, following the link block event, e.g., as described below.

In some demonstrative aspects, as shown in FIG. 5, the first wireless communication device and the second wireless communication device may set up overlapping SPs on a 60 GHz link 505 (link 1) and a sub-7 GHz link 507 (link 2). For example, the sub-7 GHz link 507 may be used, e.g., opportunistically, when the 60 GHz link 505 is blocked.

In some demonstrative aspects, an MLD-1, e.g., acting as an AP/soft-AP, and/or an MLD-2, e.g., acting as a client, may setup overlapping SPs on two links, for example, on the 60 GHz link 505 and the sub-7 GHz link 407. For example, the MLD-2 may be configured, e.g., due to PS reasons, to turn on the sub-7 GHz link 507, for example, only when the 60 GHz link 505 becomes unavailable.

For example, device 102 (FIG. 1) may perform one or more operations of, one or more functionalities of, the role of, and/or the functionality of, the first wireless communication device, e.g., the MLD-1.

For example, device 140 (FIG. 1) may perform one or more operations of, one or more functionalities of, the role of, and/or the functionality of, the second wireless communication device, e.g., the MLD-2.

In some demonstrative aspects, the MLD-1 and the MLD-2 may set up a first pair of TWT SPs 501, for example, including a first TWT SP 581 over the mmWave wireless communication link, and a second TWT SP 582 over the sub-10 GHz wireless communication link.

In some demonstrative aspects, as shown in FIG. 5, TWT SP 581 may at least partially overlap with TWT SP 582.

In some demonstrative aspects, the MLD-1 and the MLD-2 may set up a second pair of TWT SPs 503, for example, including a first TWT SP 591 over the mmWave wireless communication link, and a second TWT SP 592 over the sub-10 GHz wireless communication link.

In some demonstrative aspects, as shown in FIG. 5, TWT SP 591 may at least partially overlap with TWT SP 592.

In some demonstrative aspects, as shown in FIG. 5, there may be no link block event, e.g., no blockage, over the 60 GHz link 505 between the MLD-1 and the MLD-2, e.g., during the TWT SP 581.

In some demonstrative aspects, the MLD-1 may identify a link block event during TWT SP 591, for example, based on an identified failure of receipt of an expected response to a transmission from the MLD-1 to the MLD-2.

In some demonstrative aspects, as shown in FIG. 5, the MLD-1 may transmit a transmission to the MLD-2 over the sub-7 GHz link 507, for example, after identifying the link block event.

In some demonstrative aspects, the MLD-2 may operate at an EMLSR mode, for example, to simultaneously listen over both the 60 GHz link 505 and the sub-7 GHz link 507.

For example, the MLD-2, e.g., the non-AP MLD, may operate in the EMLSR mode on both links to use the sub-7 GHz link 507, e.g., opportunistically, for example, when the 60 GHz link 505 is blocked.

In some demonstrative aspects, as shown in FIG. 5, following the link block event, the MLD-2 may take an advantage of a Multi-Link Operation (MLO), for example, to obtain data on the sub-7 GHz link 507.

For example, as shown in FIG. 5, based on the identified link block event over the 60 GHz link 505, the MLD-1 and the MLD-2 may exchange over the sub-7 GHz link 507 a Multi User (MU) Request to Send (RTS) (MU-RTS) frame 510 and a Clear to Send (CTS) frame 512, for example, to obtain access to the sub-7 GHz link 507 for communication of one or more data frames 513.

In some demonstrative aspects, based on the identified link block event over the 60 GHz link 505, the MLD-1 and the MLD-2 may use the sub-7 Ghz link 507 to signal BF information 514 including a new BFT schedule for communication over the 60 GHz link 505.

For example, as shown in FIG. 5, the MLD-1 may transmit the BF information 514 to MLD-2 over the sub-7 Ghz link 507.

For example, the BF information 514 may indicate to the MLD-2 when to start a new BFT procedure on the 60 GHz link 505.

In some demonstrative aspects, BF information 514 may include an indication of a BF configuration for a subsequent transmission over the 60 GHz link 505.

In some demonstrative aspects, BF information 514 may include BF training setup information to setup one or more BF training windows 516 for BF training over the 60 GHz link 505, e.g., after the TWT SP 591.

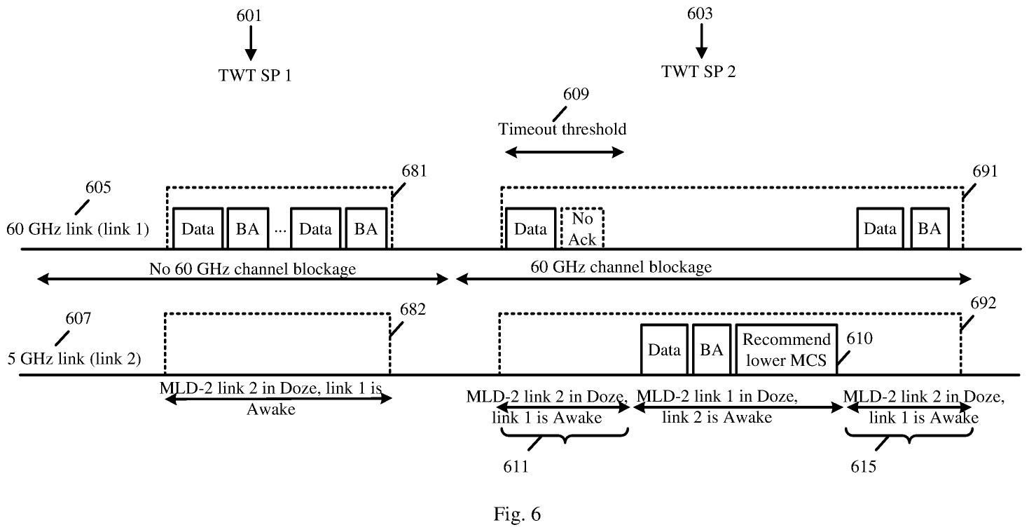

Reference is made to FIG. 6, which schematically illustrates communications between a first wireless communication device and a second wireless communication device according to a communication scheme 600 utilizing an mmWave link and a sub-10 GHz link, in accordance with some demonstrative aspects.

In some demonstrative aspects, communication scheme 600 may be configured to support communication between the first wireless communication device and the second wireless communication device, for example, following a link block event (a medium blockage event), e.g., as described below.

For example, the link block event may include a blocking of an mmWave wireless communication link between the first wireless communication device and the second wireless communication device.

In some demonstrative aspects, as shown in FIG. 6, the first wireless communication device and the second wireless communication device may start operating on lower sub-7 GHz link on an overlapping SP, for example, following the link block event, e.g., as described below.

In some demonstrative aspects, as shown in FIG. 6, the first wireless communication device and the second wireless communication device may set up overlapping SPs on a 60 GHz link 605 (link 1) and a sub-7 GHz link 607 (link 2). For example, the sub-7 GHz link 607 may be used, e.g., opportunistically, when the 60 GHz link 605 is blocked.

In some demonstrative aspects, an MLD-1, e.g., acting as an AP/soft-AP, and/or an MLD-2, e.g., acting as a client, may setup overlapping SPs on two links, for example, on the 60 GHz link 605 and the sub-7 GHz link 607. For example, the MLD-2 may be configured, e.g., due to PS reasons, to turn on the sub-7 GHz link 607, for example, only when the 60 GHz link 605 becomes unavailable.

For example, device 102 (FIG. 1) may perform one or more operations of, one or more functionalities of, the role of, and/or the functionality of, the first wireless communication device, e.g., the MLD-1.

For example, device 140 (FIG. 1) may perform one or more operations of, one or more functionalities of, the role of, and/or the functionality of, the second wireless communication device, e.g., the MLD-2.

In some demonstrative aspects, the MLD-1 and the MLD-2 may set up a first pair of TWT SPs 601, for example, including a first TWT SP 681 over the mmWave wireless communication link, and a second TWT SP 682 over the sub-10 GHz wireless communication link.

In some demonstrative aspects, as shown in FIG. 6, TWT SP 681 may at least partially overlap with TWT SP 682.

In some demonstrative aspects, the MLD-1 and the MLD-2 may set up a second pair of TWT SPs 603, for example, including a first TWT SP 691 over the mmWave wireless communication link, and a second TWT SP 692 over the sub-10 GHz wireless communication link.

In some demonstrative aspects, as shown in FIG. 6, TWT SP 691 may at least partially overlap with TWT SP 692.

In some demonstrative aspects, as shown in FIG. 6, there may be no link block event, e.g., no blockage, over the 60 GHz link 605 between the MLD-1 and the MLD-2, e.g., during the TWT SP 681.

In some demonstrative aspects, as shown in FIG. 6, the 60 GHz link 605 between the MLD-1 and the MLD-2 may be in an active state during period 611, and the sub-7 GHz link 607 between the MLD-1 and the MLD-2 may be in a low power state during period 611, for example, as long a link blockage event over the 60 Ghz link 605 is not detected.

In some demonstrative aspects, the MLD-1 may identify a link block event during TWT SP 691, for example, based on an identified failure of receipt of an expected response to a transmission from the MLD-1 to the MLD-2.

In some demonstrative aspects, as shown in FIG. 6, the MLD-2 may identify the link block event, for example, based on an identified failure of receipt of a data transmission from the MLD-1 over the mmWave wireless communication link within a threshold time 609 since a beginning of TWT SP 691.

In some demonstrative aspects, as shown in FIG. 6, the MLD-2 may continue to operate in the awake state over the 60 GHz link 605 (link 1), and to operate in the doze state over the sub-7 GHz link 607 (link 2), for example, during a time period 611, for example, as long as the MLD-2 has not identified the link block event over the 60 GHz link 605.

In some demonstrative aspects, as shown in FIG. 6, the MLD-2 may switch its STA on the sub-7 GHz link 607 (link 2) from a low power state to an active state, for example, based on the identified link block event over the 60 GHz link 605. For example, the MLD-2 may activate its STA on the sub-7 GHz link 607 (link 2), for example, when the MLD-2 does not receive any expected frame transmission within the specified timeout threshold 609 on the 60 GHz link 605 (link 1).

For example, as shown in FIG. 6, the MLD-2 may operate a sub-7 GHz STA of the MLD-2 to receive a data transmission from the MLD-1 over the sub-7 GHz link 607, for example, based on identifying the link block event.

In some demonstrative aspects, following the link block event, a non-AP MLD, e.g., implemented by the MLD-2, may turn on the sub-7 GHz link 607, for example, to recommend to an AP MLD, e.g., implemented by the MLD-1, to use a lower order of an MCS for communication on the 60 GHz link 605, e.g., as described below.

In some demonstrative aspects, the non-AP MLD, e.g., implemented by the MLD-2, may utilize the sub-7 GHz link 607, e.g., opportunistically, for example, when the 60 GHz link 605 is blocked with respect to communications at a high order of the MCS.

In some demonstrative aspects, the non-AP MLD, e.g., implemented by the MLD-2, may utilize the sub-7 GHz link 607 to recommend to the AP MLD, e.g., implemented by the MLD-1, to lower an order of the MCS used on the 60 GHz link 605.

In some demonstrative aspects, as shown in FIG. 6, the MLD-2 may transmit an MCS recommendation 610 to the MLD-1 over the sub-7 GHz link 607, for example, to recommend to reduce an order of an MCS for communication over the 60 GHz link 605.

In some demonstrative aspects, the MLD-1 may transmit a data transmission over the 60 GHz link 605, for example, with a lower order MCS, e.g., based on the MCS recommendation.

In some demonstrative aspects, as shown in FIG. 6, the 60 GHz link 605 between the MLD-1 and the MLD-2 may be in an active state during a time period 615, and the sub-7 GHz link 607 between the MLD-1 and the MLD-2 may be in a low power state during period 615.

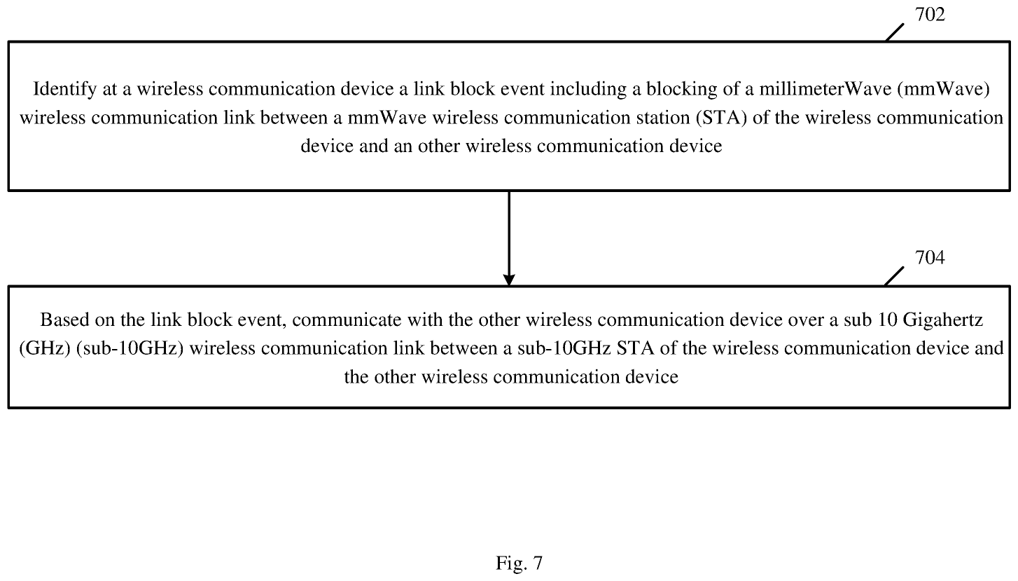

Reference is made to FIG. 7, which schematically illustrates a method of communication over an mmWave wireless communication channel assisted by communication over a sub-10 GHz channel, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include identifying at a wireless communication device a link block event including a blocking of an mmWave wireless communication link between a mmWave STA of the wireless communication device and an other wireless communication device. For example, controller 124 (FIG. 1) may be configured to cause, trigger, and/or control device 102 (FIG. 1) to identify the link block event including the blocking of the mmWave wireless communication link between mmWave STA 141 (FIG. 1) and device 140 (FIG. 1), e.g., as described above.

As indicated at block 704, the method may include, based on the link block event, communicating with the other wireless communication device over a sub-10 GHz wireless communication link between a sub-10 GHz STA of the wireless communication device and the other wireless communication device. For example, controller 124 (FIG. 1) may be configured to cause, trigger, and/or control device 102 (FIG. 1) to communicate with device 140 (FIG. 1) over the sub-10 GHz wireless communication link between device 102 (FIG. 1) and device 140 (FIG. 1), for example, based on the link block event, e.g., as described above.

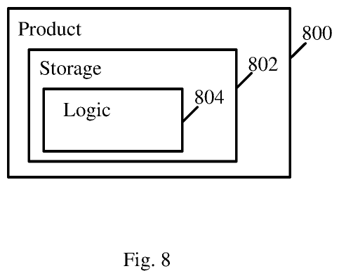

Reference is made to FIG. 8, which schematically illustrates a product of manufacture 800, in accordance with some demonstrative aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1); to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities; and/or to perform, trigger and/or implement one or more operations and/or functionalities described with reference to the FIGS. 1, 2, 3, 4, 5, 6, and/or 7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine-readable storage media 802 may include one or more types of computer-readable storage media capable of storing data, including volatile memory, non-volatile memory, removable or non-removable memory, erasable or non-erasable memory, writeable or re-writeable memory, and the like. For example, machine-readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication device to identify a link block event comprising a blocking of a millimeterWave (mmWave) wireless communication link between a mmWave wireless communication station (STA) of the wireless communication device and an other wireless communication device; and based on the link block event, communicate with the other wireless communication device over a sub 10 Gigahertz (GHz) (sub-10 GHz) wireless communication link between a sub-10 GHz STA of the wireless communication device and the other wireless communication device.

Example 2 includes the subject matter of Example 1, and optionally, wherein the apparatus is configured to cause the wireless communication device to setup a first Service Period (SP) over the mmWave wireless communication link, and a second SP over the sub-10 GHz wireless communication link, wherein the second SP at least partially overlaps with the first SP; operate the mmWave STA of the wireless communication device to communicate with the other wireless communication device over the mmWave wireless communication link during the first SP; and based on identifying the link block event during the first SP, operate the sub-10 Ghz STA of the wireless communication device to communicate with the other wireless communication device over the sub-10 GHz wireless communication link during the second SP.

Example 3 includes the subject matter of Example 2, and optionally, wherein the apparatus is configured to cause the wireless communication device to, based on the link block event, operate the sub-10 GHz STA of the wireless communication device to transmit Beamforming (BF) information to the other wireless communication device over the sub-10 GHz wireless communication link.

Example 4 includes the subject matter of Example 3, and optionally, wherein the BF information comprises an indication of a BF configuration for a subsequent transmission over the mmWave wireless communication link.

Example 5 includes the subject matter of Example 3 or 4, and optionally, wherein the BF information comprises BF training setup information to setup one or more BF training windows for the mmWave wireless communication link.

Example 6 includes the subject matter of any one of Examples 2-5, and optionally, wherein the apparatus is configured to cause the wireless communication device to setup the first SP as a main SP for communication with the other wireless communication device, and to setup the second SP as a backup SP to be activated based on the link block event.

Example 7 includes the subject matter of any one of Examples 2-6, and optionally, wherein the first SP comprises a first Target Wake Time (TWT) SP over the mmWave wireless communication link, and the second SP comprises a second TWT SP over the sub-10 GHz wireless communication link.

Example 8 includes the subject matter of any one of Examples 1-7, and optionally, wherein the apparatus is configured to cause the wireless communication device to identify the link block event based on an identified failure of a data transmission from the mmWave STA of the wireless communication device to the other wireless communication device; and based on the link block event, operate the sub-10 GHz STA of the wireless communication device to transmit the data transmission to the other wireless communication device over the sub-10 GHz wireless communication link.

Example 9 includes the subject matter of any one of Examples 1-8, and optionally, wherein the apparatus is configured to cause the wireless communication device to identify the link block event based on an identified failure to receive an expected data transmission from the other wireless communication device over the mmWave wireless communication link; and based on the link block event, operate the sub-10 GHz STA of the wireless communication device to receive the data transmission from the other wireless communication device over the sub-10 Ghz wireless communication link.

Example 10 includes the subject matter of Example 9, and optionally, wherein the apparatus is configured to cause the wireless communication device to operate at an Enhanced Multi-Link Single Radio (EMLSR) mode to simultaneously listen over both the mmWave wireless communication link and the sub-10 Ghz wireless communication link.

Example 11 includes the subject matter of any one of Examples 1-10, and optionally, wherein the apparatus is configured to cause the wireless communication device to switch the sub-10 Ghz STA of the wireless communication device from a low power state to an active state based on the link block event.

Example 12 includes the subject matter of any one of Examples 1-11, and optionally, wherein the apparatus is configured to cause the wireless communication device to operate the sub-10 Ghz STA of the wireless communication device to transmit over the sub-10 GHz link a transmission configured to indicate the link block event to the other wireless communication device.

Example 13 includes the subject matter of any one of Examples 1-12, and optionally, wherein the apparatus is configured to cause the wireless communication device to identify the link block event based on an identified failure of receipt of an expected transmission from the other wireless communication device over the mmWave wireless communication link.

Example 14 includes the subject matter of any one of Examples 1-13, and optionally, wherein the apparatus is configured to cause the wireless communication device to identify the link block event based on an identified failure of receipt of an expected response to a transmission from the mmWave STA of the wireless communication device over the mmWave wireless communication link.

Example 15 includes the subject matter of any one of Examples 1-14, and optionally, wherein the apparatus is configured to cause the wireless communication device to identify the link block event based on an identified failure of receipt of a transmission from the other wireless communication device over the mmWave wireless communication link within a threshold time since a beginning of a Service Period (SP).

Example 16 includes the subject matter of any one of Examples 1-15, and optionally, wherein the apparatus is configured to cause the wireless communication device to identify the link block event based on an identified predefined change of a link condition corresponding to the mmWave wireless communication link.

Example 17 includes the subject matter of any one of Examples 1-16, and optionally, wherein the apparatus is configured to cause the wireless communication device to, based on the link block event, operate the sub-10 Ghz STA of the wireless communication device to transmit to the other wireless communication device a recommendation to reduce an order of a Modulation and Coding Scheme (MCS) for communication over the mmWave wireless communication link.

Example 18 includes the subject matter of any one of Examples 1-17, and optionally, wherein the wireless communication device comprises an Access Point (AP) device, the sub-10 GHz STA comprises a sub-10 GHz AP, and the mmWave STA comprises an mmWave AP.

Example 19 includes the subject matter of any one of Examples 1-17, and optionally, wherein the wireless communication device comprises a non-Access Point (non-AP) device, the sub-10 GHz STA comprises a sub-10 GHz non-AP STA, and the mmWave STA comprises an mmWave non-AP STA.

Example 20 includes the subject matter of any one of Examples 1-19, and optionally, wherein the wireless communication device comprises a Multi-Link Device (MLD).

Example 21 includes the subject matter of any one of Examples 1-20, and optionally, wherein the sub-10 GHz wireless communication channel comprises a sub-7 GHz channel.

Example 22 includes the subject matter of any one of Examples 1-21, and optionally, wherein the mmWave wireless communication channel comprises a 60 GHz channel.

Example 23 includes the subject matter of any one of Examples 1-22, and optionally, comprising at least one radio to over the mmWave wireless communication link and the sub-10 GHz wireless communication link.

Example 24 includes the subject matter of Example 23, and optionally, comprising one or more antennas connected to the radio, and a processor to execute instructions of an operating system of the wireless communication device.

Example 25 comprises a wireless communication device comprising the apparatus of any of Examples 1-24.

Example 26 comprises an apparatus comprising means for executing any of the described operations of any of Examples 1-24.

Example 27 comprises a product comprising one or more tangible computer-readable non-transitory storage media comprising computer-executable instructions operable to, when executed by at least one processor, enable the at least one processor to cause a wireless communication device to perform any of the described operations of any of Examples 1-24.

Example 28 comprises an apparatus comprising: a memory interface; and processing circuitry configured to: perform any of the described operations of any of Examples 1-24.

Example 29 comprises a method comprising any of the described operations of any of Examples 1-24.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication device to:
identify a link block event comprising a blocking of a millimeterWave (mmWave) wireless communication link between a mmWave wireless communication station (STA) of the wireless communication device and an other wireless communication device; and
based on the link block event, communicate with the other wireless communication device over a sub 10 Gigahertz (GHz) (sub-10 GHz) wireless communication link between a sub-10 GHz STA of the wireless communication device and the other wireless communication device.

2. The apparatus of claim 1 configured to cause the wireless communication device to:
setup a first Service Period (SP) over the mmWave wireless communication link, and a second SP over the sub-10 GHz wireless communication link, wherein the second SP at least partially overlaps with the first SP;
operate the mmWave STA of the wireless communication device to communicate with the other wireless communication device over the mmWave wireless communication link during the first SP; and
based on identifying the link block event during the first SP, operate the sub-10 Ghz STA of the wireless communication device to communicate with the other wireless communication device over the sub-10 GHz wireless communication link during the second SP.

3. The apparatus of claim 2 configured to cause the wireless communication device to, based on the link block event, operate the sub-10 GHz STA of the wireless communication device to transmit Beamforming (BF) information to the other wireless communication device over the sub-10 GHz wireless communication link.

4. The apparatus of claim 3, wherein the BF information comprises an indication of a BF configuration for a subsequent transmission over the mmWave wireless communication link.

5. The apparatus of claim 3, wherein the BF information comprises BF training setup information to setup one or more BF training windows for the mmWave wireless communication link.

6. The apparatus of claim 2 configured to cause the wireless communication device to setup the first SP as a main SP for communication with the other wireless communication device, and to setup the second SP as a backup SP to be activated based on the link block event.

7. The apparatus of claim 2, wherein the first SP comprises a first Target Wake Time (TWT) SP over the mmWave wireless communication link, and the second SP comprises a second TWT SP over the sub-10 GHz wireless communication link.

8. The apparatus of claim 1 configured to cause the wireless communication device to:
identify the link block event based on an identified failure of a data transmission from the mmWave STA of the wireless communication device to the other wireless communication device; and
based on the link block event, operate the sub-10 GHz STA of the wireless communication device to transmit the data transmission to the other wireless communication device over the sub-10 GHz wireless communication link.

9. The apparatus of claim 1 configured to cause the wireless communication device to:
identify the link block event based on an identified failure to receive an expected data transmission from the other wireless communication device over the mmWave wireless communication link; and
based on the link block event, operate the sub-10 GHz STA of the wireless communication device to receive the data transmission from the other wireless communication device over the sub-10 Ghz wireless communication link.

10. The apparatus of claim 9 configured to cause the wireless communication device to operate at an Enhanced Multi-Link Single Radio (EMLSR) mode to simultaneously listen over both the mmWave wireless communication link and the sub-10 Ghz wireless communication link.

11. The apparatus of claim 1 configured to cause the wireless communication device to switch the sub-10 Ghz STA of the wireless communication device from a low power state to an active state based on the link block event.

12. The apparatus of claim 1 configured to cause the wireless communication device to operate the sub-10 Ghz STA of the wireless communication device to transmit over the sub-10 GHz link a transmission configured to indicate the link block event to the other wireless communication device.

13. The apparatus of claim 1 configured to cause the wireless communication device to identify the link block event based on an identified failure of receipt of an expected transmission from the other wireless communication device over the mmWave wireless communication link.

14. The apparatus of claim 1 configured to cause the wireless communication device to identify the link block event based on an identified failure of receipt of an expected response to a transmission from the mmWave STA of the wireless communication device over the mmWave wireless communication link.

15. The apparatus of claim 1 configured to cause the wireless communication device to identify the link block event based on an identified failure of receipt of a transmission from the other wireless communication device over the mmWave wireless communication link within a threshold time since a beginning of a Service Period (SP).

16. The apparatus of claim 1 configured to cause the wireless communication device to identify the link block event based on an identified predefined change of a link condition corresponding to the mmWave wireless communication link.

17. The apparatus of claim 1 configured to cause the wireless communication device to, based on the link block event, operate the sub-10 Ghz STA of the wireless communication device to transmit to the other wireless communication device a recommendation to reduce an order of a Modulation and Coding Scheme (MCS) for communication over the mmWave wireless communication link.

18. The apparatus of claim 1, wherein the sub-10 GHz wireless communication channel comprises a sub-7 GHz channel.

19. The apparatus of claim 1, wherein the mmWave wireless communication channel comprises a 60 GHz channel.

20. The apparatus of claim 1 comprising at least one radio to over the mmWave wireless communication link and the sub-10 GHz wireless communication link.

21. The apparatus of claim 20 comprising one or more antennas connected to the radio, and a processor to execute instructions of an operating system of the wireless communication device.

22. A product comprising one or more tangible computer-readable non-transitory storage media comprising computer-executable instructions operable to, when executed by at least one processor, enable the at least one processor to cause a wireless communication device to:
identify a link block event comprising a blocking of a millimeterWave (mmWave) wireless communication link between a mmWave wireless communication station (STA) of the wireless communication device and an other wireless communication device; and
based on the link block event, communicate with the other wireless communication device over a sub 10 Gigahertz (GHz) (sub-10 GHz) wireless communication link between a sub-10 GHz STA of the wireless communication device and the other wireless communication device.

23. The product of claim 22, wherein the instructions, when executed, cause the wireless communication device to:
setup a first Service Period (SP) over the mmWave wireless communication link, and a second SP over the sub-10 GHz wireless communication link, wherein the second SP at least partially overlaps with the first SP;
operate the mmWave STA of the wireless communication device to communicate with the other wireless communication device over the mmWave wireless communication link during the first SP; and
based on identifying the link block event during the first SP, operate the sub-10 Ghz STA of the wireless communication device to communicate with the other wireless communication device over the sub-10 GHz wireless communication link during the second SP.

24. An apparatus for a wireless communication device, the apparatus comprising:
means for identifying a link block event comprising a blocking of a millimeterWave (mmWave) wireless communication link between a mmWave wireless communication station (STA) of the wireless communication device and an other wireless communication device; and
mean for causing the wireless communication device to, based on the link block event, communicate with the other wireless communication device over a sub 10 Gigahertz (GHz) (sub-10 GHz) wireless communication link between a sub-10 GHz STA of the wireless communication device and the other wireless communication device.

25. The apparatus of claim 24 comprising means for causing the wireless communication device to operate the sub-10 Ghz STA of the wireless communication device to transmit over the sub-10 GHz link a transmission configured to indicate the link block event to the other wireless communication device.
